(19) United States
(12) Patent Application Publication
(10) Pub. No.: US 2025/0319777 A1
(43) Pub. Date: Oct. 16, 2025

(54) ELECTRIC VEHICLE

(71) Applicants: Hyundai Motor Company, Seoul (KR); Kia Corporation, Seoul (KR)

(72) Inventors: Young Seul LIM, Seoul (KR); Myung Ho KIM, Incheon (KR); Ki Jong LEE, Hwaseong-si (KR); Kang Ho JEONG, Hwaseong-si (KR)

(73) Assignees: Hyundai Motor Company, Seoul (KR); Kia Corporation, Seoul (KR)

(21) Appl. No.: 18/953,362

(22) Filed: Nov. 20, 2024

(30) Foreign Application Priority Data
Apr. 15, 2024 (KR) 10-2024-0050250

(51) Int. Cl. B60L 50/51; B60L 50/60; B60L 53/20; H02H 3/08; H02M 7/5387

(52) U.S. Cl. CPC B60L 50/51; B60L 50/60; B60L 53/20; H02H 3/083; H02M 7/5387; B60L 2210/42; B60L 2240/526; B60L 2260/20

(57) ABSTRACT

An electric vehicle including an overcurrent protection circuit that includes a charging capacitor, a first element connected in series with the charging capacitor and selectively allowing current conduction in a first direction depending on a turn-on/off state, and a second element connected in parallel with the first element and allowing current conduction in a second direction opposite to the first direction, and is connected between DC terminals and a node formed by connecting one end of each of a plurality of switches.

### CROSS-REFERENCE TO RELATED APPLICATION

This application claims priority from Korean Patent Application No. 10-2024-0050250, filed on Apr. 15, 2024 in the Korean Intellectual Property Office, the disclosure of which is incorporated herein by reference in its entirety.

### BACKGROUND

### 1. Technical Field

The present disclosure relates to an electric vehicle that alleviates damage to a motor driving device.

### 2. Description of the Related Art

Recently, according to the global trend of reducing carbon dioxide emissions, instead of typical internal combustion engine vehicles that generate driving power through the combustion of fossil fuels, demand for electric vehicles, which generate driving power by driving a motor with electrical energy stored in an energy storage device such as a battery, is increasing significantly.

An electric vehicle is equipped with an inverter to drive a motor, and in general, one end of each phase winding included in the motor is connected to one inverter and the other ends of windings are connected to each other to form a Y-connection.

When the motor is driven, a switch in the inverter is turned on/off by pulse width modulation control and thus a line voltage is applied to the windings of the Y-connected motor to generate alternating current, thereby generating torque.

The fuel efficiency of an electric vehicle that uses the torque generated by such a motor as power is determined by the power conversion efficiency between the inverter and the motor, and thus it is necessary to maximize the power conversion efficiency of the inverter and the efficiency of the motor in order to improve the fuel efficiency.

The efficiency of the inverter-motor system is mainly determined by voltage utilization of the inverter. If an operating point of a vehicle, which is determined by the relationship between the motor speed and torque, is formed in a period in which the voltage utilization is high, the fuel efficiency of the vehicle can be improved.

However, as the number of windings of the motor is increased in order to increase the maximum torque of the motor, the period with high voltage utilization becomes farther from a low torque area, which is the main operating point of the vehicle, which may lead to a problem of poor fuel efficiency. In addition, from the perspective of fuel efficiency, if design is performed such that the main operating point is included in the period with high voltage utilization, the maximum torque of the motor may be limited, causing a problem of deterioration in acceleration and starting performance of the vehicle.

In the field of technology, as motor driving technology capable of improving system efficiency while covering both low and high power periods with a single motor is required, technology for driving one motor in two different modes using two inverters and a mode switch is being introduced.

The matters described as background technology above are only for the purpose of improving understanding of the background of the present disclosure and should not be taken as recognition that they correspond to prior art already known to those skilled in the art.

### SUMMARY

Therefore, the present disclosure has been made in view of the above problems, and it is an object of the present disclosure to provide an electric vehicle capable of protecting a motor driving device from reverse surge overcurrent that may occur during a charging operation of the electric vehicle.

The object of the present disclosure is not limited to the object mentioned above, and other objects that are not mentioned will be clearly understood by those skilled in the art from the description below.

In accordance with an aspect of the present disclosure, the above and other objects can be accomplished by the provision of an electric vehicle including a motor having a plurality of windings, a first inverter having DC terminals and including a plurality of first legs each connected to a first end of each of the plurality of windings, respectively, and a second inverter connected to the DC terminals and including a plurality of second legs each connected to a second end of each of the plurality of windings, respectively, a plurality of switches each having a first end interconnected to form a node and a second end connected to the second end of each of the plurality of windings, respectively, a battery connected to the DC terminals, an overcurrent protection circuit including a charging capacitor, a first element connected in series with the charging capacitor and selectively allowing current conduction in a first direction depending on a turn-on/off state, and a second element connected in parallel with the first element and allowing current conduction in a second direction opposite to the first direction, and connected between the node and the DC terminals, and a controller configured to control the turn-on/off state of the first element.

For example, the first direction may be a direction from the node to the DC terminals, and the first element may allow current conduction in the first direction in a turn-on state.

For example, the first element may include an anti-parallel diode configured to allow current conduction in the second direction.

For example, the second element may share a current flowing in the second direction with the anti-parallel diode of the first element, and the second element may conduct a larger portion of the current compared to the anti-parallel diode.

For example, the second element may include a diode having an anode connected to the DC terminals and a cathode connected to the charging capacitor.

For example, the overcurrent protection circuit may further include a discharge resistor connected in parallel with the charging capacitor.

For example, the overcurrent protection circuit may further include at least one charging switch connected in series with the discharge resistor to selectively allow current conduction between the discharge resistor and the first element.

For example, the controller may turn off the first element when driving the motor.

For example, the electric vehicle according to an embodiment may further include an input terminal having a first end connected to the node, and a second end connected to the DC terminals, where an external DC voltage is applied to the input terminal.

For example, the controller may turn on the first element when charging the battery using the external DC voltage applied to the input terminal.

For example, the controller may boost the external DC voltage through the motor and the first inverter and charge the battery with the external DC voltage when the external DC voltage corresponds to a first voltage, and charge the battery while maintaining the external DC voltage through the second inverter when the external DC voltage corresponds to a second voltage that is higher than the first voltage.

For example, the controller may control turn-on/off state of the plurality of switches in response to a driving mode of the motor.

For example, the driving mode of the motor may include a first mode for driving the motor only with the first inverter, and a second mode for driving the motor with the first inverter and the second inverter.

For example, the controller may turn on the plurality of switches when the driving mode of the motor is the first mode.

For example, the controller may turn off the plurality of switches when the driving mode of the motor is the second mode.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram illustrating a motor driving system of an electric vehicle according to an embodiment of the present disclosure;

FIG. 2 and FIG. 3 are diagrams for describing an operation of charging a battery through the motor driving system of the electric vehicle according to an embodiment of the present disclosure;

FIG. 4 and FIG. 5 are diagrams for describing an overcurrent protection operation of the motor driving system of the electric vehicle according to an embodiment of the present disclosure; and

FIG. 6 and FIG. 7 are diagrams for describing motor driving modes of the motor driving system of the electric vehicle according to an embodiment of the present disclosure.

### DETAILED DESCRIPTION

Specific structural and functional descriptions of the embodiments of the present disclosure, disclosed in the present specification or application, are merely illustrative for the purpose of explaining the embodiments according to the present disclosure, and the embodiments according to the present disclosure may be implemented in various forms and should not be construed as being limited to the embodiments described in this specification or application.

Since the embodiments according to the present disclosure can be modified in various manners and have various forms, specific embodiments will be illustrated in the drawings and described in detail in the specification or application. However, this is not intended to limit the embodiments according to the concept of the present disclosure to a specific disclosed form, and should be understood to include all changes, equivalents, and substitutes included in the spirit and technical scope of the present disclosure.

All terms including technical or scientific terms have the same meanings as generally understood by a person having ordinary skill in the art to which the present disclosure pertains unless mentioned otherwise. Generally used terms, such as terms defined in a dictionary, should be interpreted to coincide with meanings of the related art from the context. Unless differently defined in the present disclosure, such terms should not be interpreted in an ideal or excessively formal manner.

Hereinafter, embodiments disclosed in the present specification will be described in detail with reference to the attached drawings. However, identical or similar components will be assigned the same reference numeral, and redundant descriptions thereof will be omitted.

In the description of the following embodiments, the term “preset” means that the value of a parameter is predetermined when the parameter is used in a process or an algorithm. Depending on embodiments, the value of a parameter may be set when a process or an algorithm starts or may be set during a period in which the process or the algorithm is performed.

The terms “module” and “unit or part” used to signify components are used herein to help the understanding of the components and thus they should not be considered as having specific meanings or roles.

In the following description of the embodiments disclosed in the present specification, a detailed description of known functions and configurations incorporated herein will be omitted when it may obscure the subject matter of the present disclosure. In addition, the accompanying drawings are provided only for ease of understanding of the embodiments disclosed in the present specification, do not limit the technical spirit disclosed herein, and include all changes, equivalents and substitutes included in the spirit and scope of the present disclosure.

The terms “first” and/or “second” are used to describe various components, but such components are not limited by these terms. The terms are used to discriminate one component from another component.

When a component is “coupled” or “connected” to another component, it should be understood that a third component may be present between the two components although the component may be directly coupled or connected to the other component. When a component is “directly coupled” or “directly connected” to another component, it should be understood that no element is present between the two components.

An element described in the singular form is intended to include a plurality of elements unless the context clearly indicates otherwise, and terms such as “at least one” and “one or more” are written to include all combinations that can be derived through objects described later.

In the present specification, it will be further understood that the term “comprise” or “include” specifies the presence of a stated feature, figure, step, operation, component, part or combination thereof, but does not preclude the presence or addition of one or more other features, figures, steps, operations, components, or combinations thereof.

In addition, a unit or a control unit included in names such as a motor control unit (MCU) and a hybrid control unit (HCU) is merely a term widely used in naming a control device that controls specific vehicle functions and does not mean a generic functional unit.

A controller may include a communication device that communicates with other controllers or sensors to control the functions of the controller, a memory that stores an operating system, logic instructions, input/output information, etc., and one or more processors that perform determination, computation, and decisions necessary to control the functions.

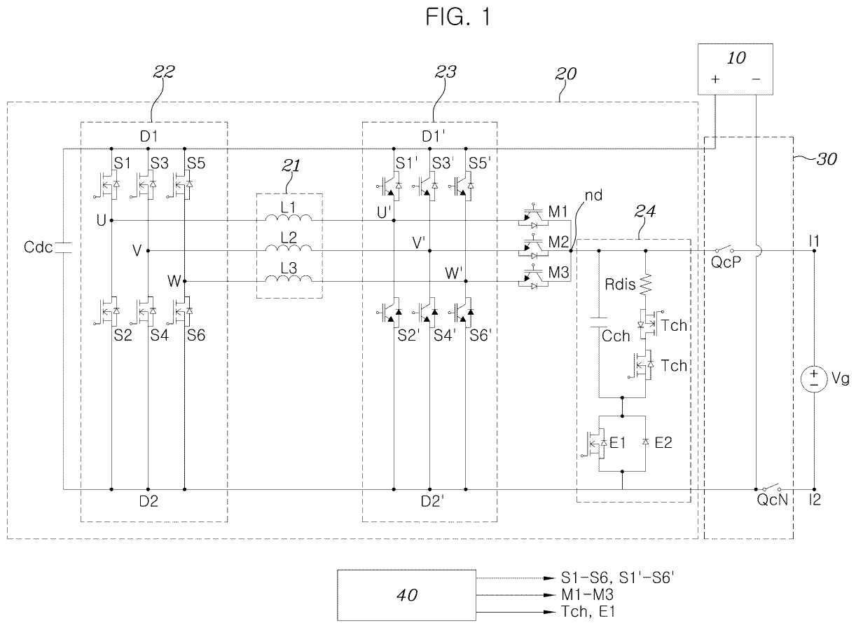

In an electric vehicle according to an embodiment of the present disclosure, reverse surge overcurrent that occurs during battery charging is shared through an element that is connected in parallel with an element for connecting a charging capacitor and allows reverse current conduction, and accordingly, damage to a motor driving device is alleviated when the reverse surge overcurrent occurs. Hereinafter, first, a motor driving system of the electric vehicle according to an embodiment of the present disclosure will be described with reference to FIG. 1.

FIG. 1 is a diagram illustrating the motor driving system of the electric vehicle according to an embodiment of the present disclosure.

Referring to FIG. 1, the electric vehicle may include a battery 10 having a positive terminal (+) and a negative terminal (−), a motor driving device 20, a junction block 30, and a controller 40. The junction block 30 electrically connects the battery 10, the motor driving device 20, and input terminals I1 and I2 to which an external DC voltage for charging the battery 10 is applied, and may include charging relays QcP and QcN that control the electrical connection state of the negative terminal (−) of the battery 10 and the input terminal 12.

The motor driving device 20 may include a motor 21, a first inverter 22, a second inverter 23, a plurality of switches M1, M2, and M3, and an overcurrent protection circuit 24.

The motor 21 may have a plurality of windings L1, L2, and L3 corresponding to a plurality of phases.

The first inverter 22 has AC terminals U, V, and W corresponding to the plurality of phases and DC terminals D1 and D2 connected to the positive terminal (+) and negative terminal (−) of the battery 10 and may include a plurality of legs (e.g., first legs) S1-S2, S3-S4, and S5-S6 each connected to one end (e.g., first end) of each of the plurality of windings L1, L2, and L3. The plurality of legs S1-S2, S3-S4, and S5-S6 is connected between the DC terminals D1 and D2 and may be connected to correspond to the AC terminals U, V, and W. Additionally, a DC capacitor Cdc may be connected between the DC terminals D1 and D2.

The second inverter 23 has AC terminals U′, V′, and W′ corresponding to a plurality of phases and a DC terminal D1′ and D2′ connected to the DC terminals D1 and D2 of the first inverter 22, and may include a plurality of legs (e.g., second legs) S1′-S2′, S3′-S4′, and S5′-S6′ each connected to the other end (e.g., second end) of each of the plurality of windings L1, L2, and L3. The plurality of legs S′-S2′, S3′-S4′, and S5′-S6′ is connected between the DC terminals D1′ and D2′ and may be connected to correspond to the AC terminals U′, V′, and W′.

In the present embodiment, a leg refers to a configuration in which a plurality of switch elements is connected, and each switch element may be implemented as a transistor such as a metal oxide semiconductor field effect transistor (MOSFET) or an insulated gate bipolar transistor (IGBT). The switch elements may be configured as the same type of transistor or different types of transistors.

One end (e.g, first end) of the switch M1, one end of the switch M2, and one end of the switch M3 may be connected to form a node nd, and the other ends (e.g., second ends) of the switches M1, M2, and M3 may be connected to the plurality of windings L1, L2, and L3. Each of the plurality of switches M1, M2, and M3 may be implemented as a transistor.

Meanwhile, the electric vehicle according to an embodiment of the present disclosure may be equipped with the overcurrent protection circuit 24 for stably charging the battery 10 and preventing damage to the motor driving device 20 during a charging operation.

The overcurrent protection circuit 24 includes a charging capacitor Cch, a first element E1, and a second element E2, and may be connected between the DC terminals D2 and D2′ and the node nd, and depending on an embodiment, may additionally include a discharge resistor Rdis and at least one charging switch Tch.

The charging capacitor Cch and the discharging resistor Rdis may be connected in parallel between the DC terminals D2 and D2′ and the node nd and may maintain the voltage of the battery 10 stable and reduce ripples generated in the current of the battery 10.

The first element E1 may be connected in series with the charging capacitor Cch and may selectively allow current conduction in a first direction depending on a turn-on/off state. Here, the first direction may be from the node nd to the DC terminals D2 and D2′, and the first element E1 may allow current conduction in the first direction from the node nd to the DC terminals D2 and D2′ in the turn-on state.

To this end, the first element E1 may be implemented as a transistor, and depending on an embodiment, an anti-parallel diode that allows current conduction in the second direction, which is opposite to the first direction, may be included as a body diode (parasitic diode). In this case, the anode of the anti-parallel diode may be connected to the DC terminals D2 and D2′ and the cathode thereof may be connected to the node nd.

Meanwhile, in the motor driving system according to an embodiment, surge overcurrent may be applied to the motor driving device 20 due to an abnormal charging operation. In this case, the surge overcurrent may occur not only in the first direction, which is the forward direction of the first element E1, but also in the second direction, which is the reverse direction of the first element E2.

For example, in a case where an external DC voltage Vg of an external charger connected to the input terminals I1 and I2 increases to be greater than the voltage on the side of the motor driving device 20 due to a voltage generation error at the external charger, a case where the external DC voltage Vg is generated due to an abnormal operation of the external charger while the charging operation is not performed on the side of the motor driving device 2, and the like, the surge overcurrent may occur in the first direction, i.e., the forward direction.

Additionally, in a case where the voltage on the side of the motor driving device 20 becomes greater than the external DC voltage Vg due to a voltage command error on the side of the external charger, surge overcurrent may occur in the second direction, i.e., the reverse direction.

Surge overcurrent in the first direction corresponding to the forward direction may be diagnosed and protected through a gate driver for turn-on/off control of the first element E1, but in a state in which there is no additional configuration, surge overcurrent in the second direction corresponding to the reverse direction cannot be diagnosed and thus the first element E1 may be damaged when surge overcurrent occurs.

Accordingly, in an embodiment of the present disclosure, damage to the first element E1 due to surge overcurrent in the reverse direction is alleviated through the second element E2 that is connected in parallel with the first element E1 and allows current conduction in the second direction corresponding to the reverse direction.

More specifically, when reverse surge overcurrent flowing in the second direction occurs, the reverse surge overcurrent passes through the second element E2 connected in parallel with the first element E2, and accordingly damage to the first element E1 is alleviated.

Additionally, when the first element E1 includes an anti-parallel diode, the second element E2 may share the reverse surge overcurrent with the anti-parallel diode of the first element E1. In this case, by allowing the second element E2 to share a larger amount of current than the anti-parallel diode of the first element E1, the amount of current applied to the first element E1 may be reduced to prevent damage to the first element E1.

To this end, the second element E2 may be implemented as an element with a higher current withstand capability compared to the anti-parallel diode of the first element E1. For example, the second element E2 may be implemented as a diode having an anode connected to the DC terminals D2 and D2′ and a cathode connected to the charging capacitor Cch. In this case, it is possible to effectively alleviate damage to the first element E1 through high current withstand capability while reducing the volume and material cost required for embedding the second element E2. However, the second element E2 may be implemented as a transistor having an anti-parallel diode as long as it allows current conduction in the second direction, and may also be implemented as the same type of element as the first element E1.

Meanwhile, depending on an embodiment, the number of second elements E2 connected in parallel with the first element E1 may be adjusted, and accordingly, the overcurrent protection circuit 24 may be configured in such a manner that a plurality of second elements E2 is connected in parallel with the first element E1.

At least one charging switch Tch may be provided to prevent damage to the first element E1 due to an abnormal turn-off state of the plurality of switches M1, M2, and M3 at the time of charging the battery 10.

In a case where the battery 10 is charged through the external DC voltage Vg, the controller 40 may turn on the first element E1 such that a voltage is generated in the charging capacitor Cch. At the time of driving the motor 21, the controller 4 may turn off the first element E1 to open the charging capacitor Cch.

More specifically, at the time of charging the battery 10 using the external DC voltage Vg, the controller 40 may turn on the plurality of switches M1, M2, and M3, perform control such that at least one of the first inverter 22 or the second inverter 23 adjusts the external DC voltage applied to the input terminals I1 and I2 to charge the battery 10, and stabilize the voltage and current of the battery 1 through the charging capacitor Cch and the discharge resistor Rdis by turning on the first element E1.

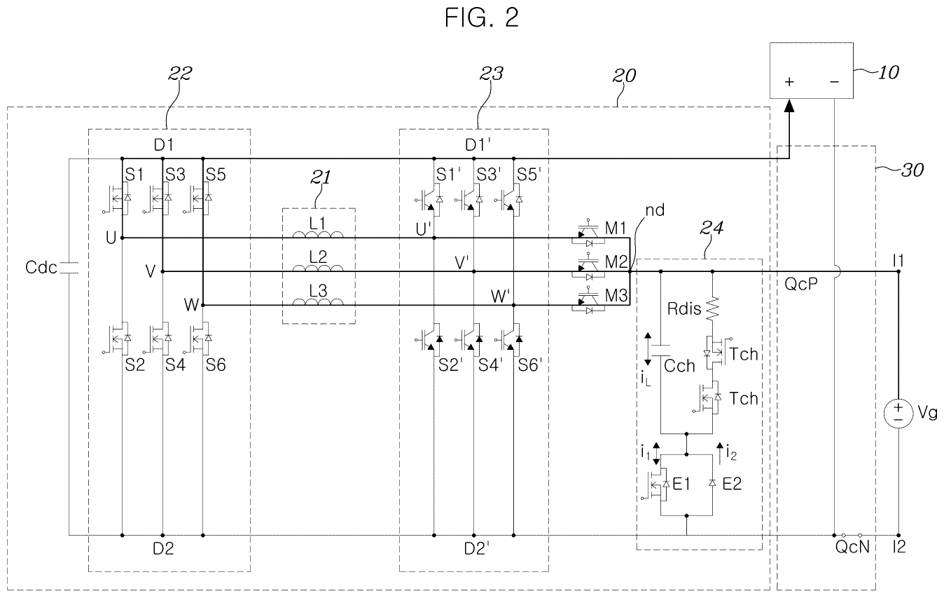

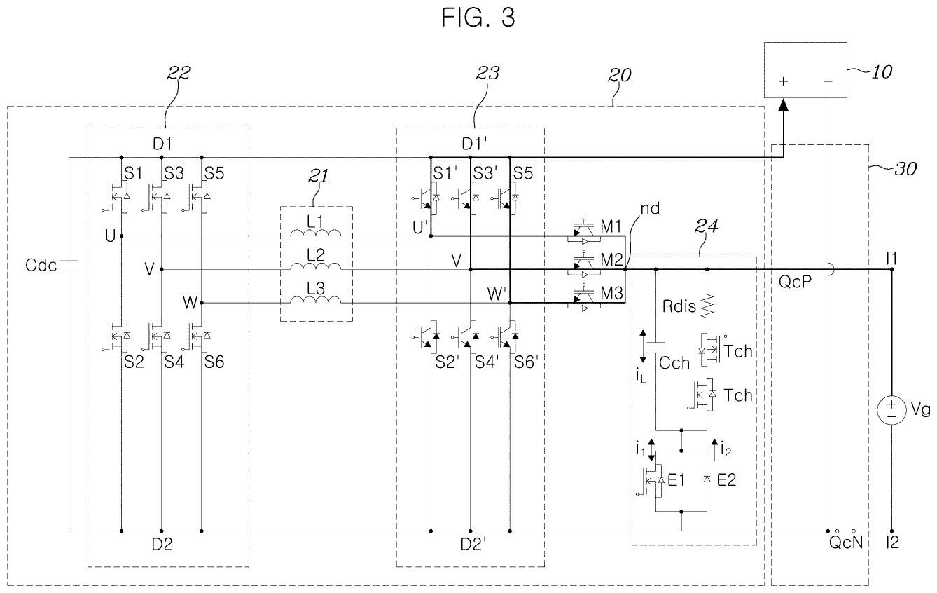

The operation of charging the battery 10 through the motor driving system of the electric vehicle according to an embodiment of the present disclosure will be described below with reference to FIG. 2 and FIG. 3.

FIG. 2 and FIG. 3 are diagrams for describing the operation of charging the battery through the motor driving system of the electric vehicle according to an embodiment of the present disclosure.

More specifically, FIG. 2 is a diagram illustrating an operation of charging the battery 10 by boosting the external DC voltage Vg, and FIG. 3 is a diagram illustrating an operation of charging the battery 10 without boosting the external DC voltage Vg.

In an embodiment of the present disclosure, when the external DC voltage Vg corresponds to a first voltage, the controller 40 may boost the external DC current Vg through the motor 21 and the first inverter 22 and charge the battery 1 with the boosted external DC voltage Vg as illustrated in FIG. 2. When the external DC voltage Vg corresponds to a second voltage higher than the first voltage, the controller 4 may charge the battery 10 while maintaining the voltage value of the external DC voltage Vg through the second inverter 23.

Here, the first voltage and the second voltage may be set in various manners depending on embodiments. For example, when the voltage of the battery 10 is 800 V, the first voltage may be set to 400 V lower than the voltage of the battery 10, and the second voltage may be set to 800 V which is the same as the voltage of the battery 10.

When charging the battery 10, the charging relays QcP and QcN included in the junction block 30 may be turned on and the plurality of switches M1, M2, and M3 may be turned on such that the other ends of the plurality of windings L1, L2, and L3 are electrically connected to the node nd.

Referring to FIG. 2, when the external DC voltage Vg corresponds to the first voltage lower than the voltage of the battery 10, the controller 40 may switch the plurality of legs S1-S2, S3-S4, and S5-S6 included in the first inverter 22 such that the first inverter 22 boosts the external DC voltage Vg and outputs the same to the battery 10.

Referring to FIG. 3, when the external DC voltage Vg corresponds to the second voltage equal to the voltage of the battery 10, the controller 40 may control top-switch elements S1′, S3′, and S5′ included in the second inverter 23 such that they are turned on, and the second inverter 23 may maintain the external DC voltage Vg and output the same to the battery 10.

During the charging operation of the battery 10 as described above, a ripple current it is generated, and the ripple current i_{L} is divided into i₁ and i₂ which respectively flow through the first element E1 and the second element E2 according to the I-V characteristics of the elements (i_{L}=i₁+i₂).

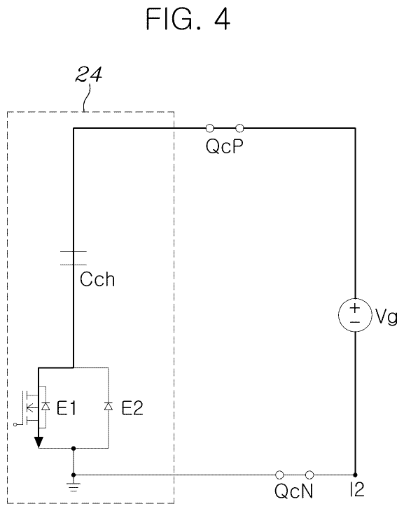

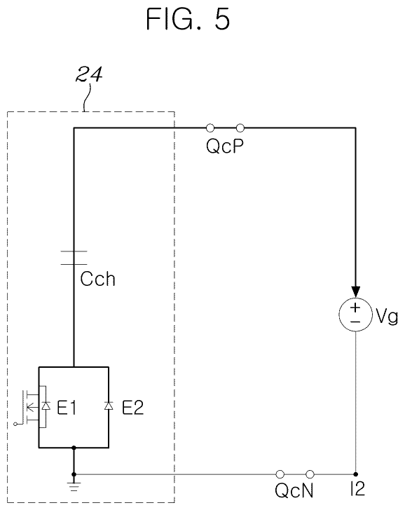

Meanwhile, the operation of protecting the motor driving device 20, particularly the first element E1, from surge overcurrent that may occur when the charging operation of the battery 10 is performed abnormally will be described below with reference to FIG. 4 and FIG. 5.

FIG. 4 and FIG. 5 are diagrams for describing the overcurrent protection operation of the motor driving system of the electric vehicle according to an embodiment of the present disclosure.

More specifically, FIG. 4 illustrates the overcurrent protection circuit 24 when surge overcurrent occurs in the forward direction (first direction), and FIG. 5 illustrates the overcurrent protection circuit 24 when surge overcurrent occurs in the reverse direction (second direction).

As illustrated in FIG. 4, when forward surge overcurrent occurs, the surge overcurrent passes through the first element E1, and thus there is a risk that the first element E1 may be damaged. However, when forward surge overcurrent occurs, damage to the first element E1 may be prevented through self-diagnosis and protection through a gate driver for turn-on/off control of the first element E1. To this end, the controller 40 may include the gate driver for turn-on/off control of the first element E1.

As illustrated in FIG. 5, when reverse surge overcurrent occurs, current burden on the first element E1 may be alleviated through the second element E2 that is connected in parallel with the first element E1 and allows current conduction in the second direction corresponding to the reverse direction, and thus damage to the first element E1 may be mitigated. Accordingly, it is possible to protect the first element E1 from the reverse surge overcurrent without constructing an additional circuit for reverse overcurrent diagnosis.

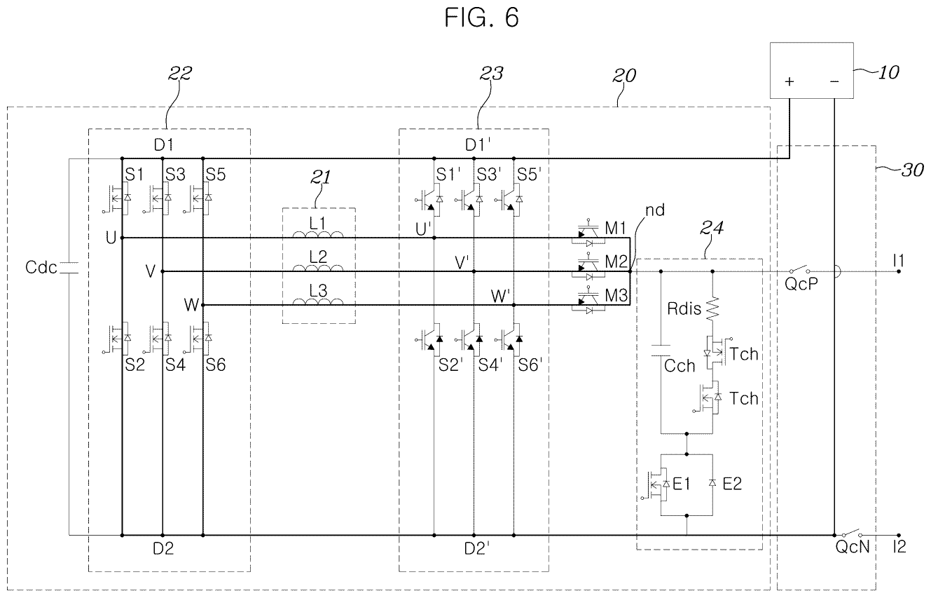

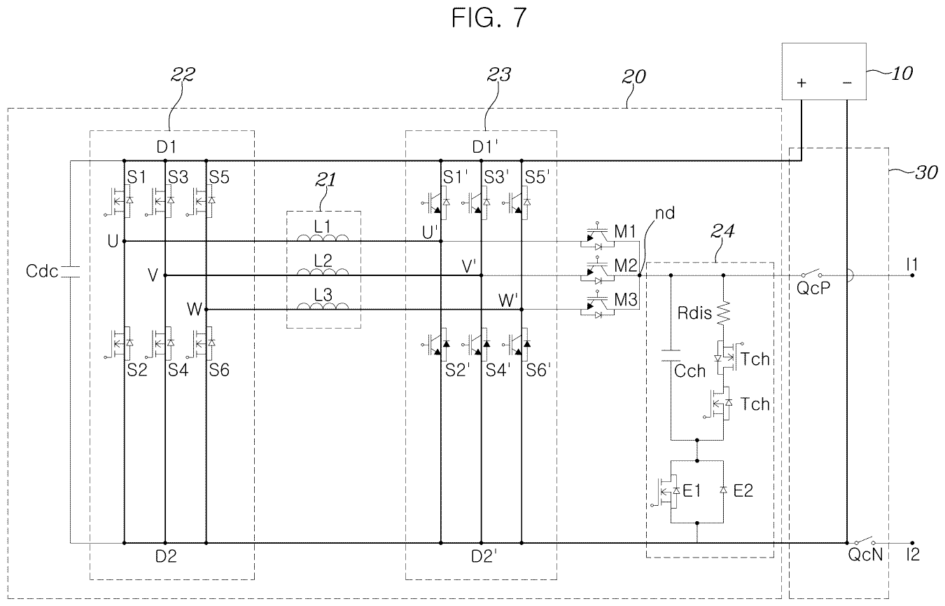

Meanwhile, the controller 40 according to an embodiment of the present disclosure may control turn-on/off states of the plurality of switches M1, M2, and M3 in response to a driving mode of the motor 21. Driving modes of the motor 21 and an operation for each driving mode will be described below with reference to FIG. 6 and FIG. 7.

FIG. 6 and FIG. 7 are diagrams for describing motor driving modes of the motor driving system of the electric vehicle according to an embodiment of the present disclosure.

The controller 40 may control turn-on/off states of the plurality of switches M1, M2, and M3 in response to a motor driving mode. In this case, the motor driving mode may include a first mode in which the motor 21 is driven only with the first inverter 22 and a second mode in which the motor 21 is driven through the first inverter 22 and the second inverter 23.

Here, the first mode may be represented as a closed end winding mode (CEW mode), and the second mode may be represented as an open end winding mode (OEW mode).

The CEW mode is a mode in which the other ends of the plurality of windings L1, L2, and L3 included in the motor 21 are electrically connected to one end of the plurality of switches M1, M2, and M3, and the motor 21 is efficiently driven only through the first inverter 22 in a low power period. The OEW mode is a mode in which the other ends of the plurality of windings L1, L2, and L3 included in the motor 21 are electrically separated from one end of the plurality of switches M1, M2, and M3, and the driving power of the motor 21 in a high power period is increased through the second inverter 23 as well as the first inverter 22.

Referring to FIG. 6, when the driving mode of the motor 21 is set to the first mode (CEW mode), the controller 40 may turn on the plurality of switches M1, M2 and M3 such that the node nd formed by connecting one end of the winding L1, one end of the winding L2, and one end of the winding L3 serves as the neutral point of the motor 21, switch the plurality of legs S1-S2, S3-S4, and S5-S6 included in the first inverter 22, and control switch elements S1′ to S6′ included in the second inverter 23 to be in a non-conduction state. In the present embodiment, switching a leg may be understood as complementarily switching a plurality of switch elements included in one leg.

Referring to FIG. 7, when the driving mode of the motor 21 is set to the second mode (OEW mode), the controller 40 may turn off the plurality of switches M1, M2 and M3 such that the node nd formed by connecting one end of the winding L1, one end of the winding L2, and one end of the winding L3 does not serve as the neutral point of the motor 21, and switch the plurality of legs S1′-S2′, S3′-S4′, and S5′-S6′ included in the second inverter 23 as well as the plurality of legs S1-S2, S3-S4, and S5-S6 included in the first inverter 22.

According to various embodiments of the present disclosure as described above, it is possible to alleviate damage to the motor driving device when reverse surge overcurrent occurs by sharing the reverse surge overcurrent through an element that is connected in parallel with an element for connecting a charging capacitor and allows reverse current conduction.

Accordingly, the motor driving device can drive the vehicle normally even when the reverse surge overcurrent occurs, and costs caused by replacement of the motor driving device can be reduced.

Additionally, if the element for sharing the reverse surge overcurrent is configured as a single diode element, it is possible to implement a structure that can alleviate damage to the motor driving device through high current withstand capability while reducing material cost and volume.

The effects that can be obtained from the present disclosure are not limited to the effects mentioned above, and other effects that are not mentioned can be clearly understood by those skilled in the art from the description below.

Although the preferred embodiments of the present disclosure have been disclosed for illustrative purposes, those skilled in the art will appreciate that various modifications, additions and substitutions are possible, without departing from the scope and spirit of the disclosure as disclosed in the accompanying claims.

What is claimed is:

1. An electric vehicle comprising:
a motor having a plurality of windings;
a first inverter having DC terminals and including a plurality of first legs each connected to a first end of each of the plurality of windings, respectively;
a second inverter connected to the DC terminals and including a plurality of second legs each connected to a second end of each of the plurality of windings, respectively;
a plurality of switches each having a first end interconnected to form a node, and a second end connected to the second end of each of the plurality of windings, respectively;
a battery connected to the DC terminals;
an overcurrent protection circuit connected between the node and the DC terminals, the overcurrent protection circuit includes:
a charging capacitor,
a first element connected in series with the charging capacitor and selectively allowing current conduction in a first direction depending on a turn-on/off state, and
a second element connected in parallel with the first element and allowing current conduction in a second direction opposite to the first direction; and
a controller configured to control the turn-on/off state of the first element.

2. The electric vehicle of claim 1, wherein the first direction is a direction from the node to the DC terminals, and the first element allows current conduction in the first direction in a turn-on state.

3. The electric vehicle of claim 1, wherein the first element includes an anti-parallel diode configured to allow current conduction in the second direction.

4. The electric vehicle of claim 3, wherein the second element shares a current flowing in the second direction with the anti-parallel diode of the first element, the second element conducts a larger portion of the current compared to the anti-parallel diode.

5. The electric vehicle of claim 1, wherein the second element includes a diode having an anode connected to the DC terminals and a cathode connected to the charging capacitor.

6. The electric vehicle of claim 1, wherein the overcurrent protection circuit further includes a discharge resistor connected in parallel with the charging capacitor.

7. The electric vehicle of claim 6, wherein the overcurrent protection circuit further includes at least one charging switch connected in series with the discharge resistor to selectively allow current conduction between the discharge resistor and the first element.

8. The electric vehicle of claim 1, wherein the controller turns off the first element when driving the motor.

9. The electric vehicle of claim 1, further including an input terminal having a first end connected to the node, and a second end connected to the DC terminals, wherein an external DC voltage is applied to the input terminal.

10. The electric vehicle of claim 9, wherein the controller turns on the first element when charging the battery using the external DC voltage applied to the input terminal.

11. The electric vehicle of claim 9, wherein the controller boosts the external DC voltage through the motor and the first inverter and charges the battery with the external DC voltage when the external DC voltage corresponds to a first voltage, and charges the battery through the second inverter while maintaining the external DC voltage when the external DC voltage corresponds to a second voltage that is higher than the first voltage.

12. The electric vehicle of claim 1, wherein the controller controls turn-on/off state of the plurality of switches based on a driving mode of the motor.

13. The electric vehicle of claim 12, wherein the driving mode of the motor includes a first mode in which the motor is driven only with the first inverter, and a second mode in which the motor is driven with both the first inverter and the second inverter.

14. The electric vehicle of claim 13, wherein the controller turns on the plurality of switches when the driving mode of the motor is the first mode.

15. The electric vehicle of claim 13, wherein the controller turns off the plurality of switches when the driving mode of the motor is the second mode.
